(19) United States
(12) Patent Application Publication
(10) Pub. No.: US 2026/0066316 A1
(43) Pub. Date: Mar. 5, 2026

(54) METHOD FOR CONTROLLING ANODE PURGE VALVE OF FUEL CELL, DEVICE, MEDIUM, AND PRODUCT

(71) Applicant: Tongji University, Yangpu District (CN)

(72) Inventors: Haifeng DAI, Yangpu District (CN); Zhaoming LIU, Yangpu District (CN); Hao YUAN, Yangpu District (CN); Wenxiong MIAO, Yangpu District (CN); Xuezhe WEI, Yangpu District (CN)

(21) Appl. No.: 18/897,289

(22) Filed: Sep. 26, 2024

(30) Foreign Application Priority Data
Aug. 30, 2024 (CN) 202411215043.1

(51) Int. Cl. H01M 8/04298; G06N 3/092; H01M 8/04223; H01M 8/0432; H01M 8/0438; H01M 8/0444; H01M 8/04537; H01M 8/04746

(52) U.S. Cl. CPC H01M 8/04305; G06N 3/092; H01M 8/04231; H01M 8/04328; H01M 8/04335; H01M 8/04388; H01M 8/04395; H01M 8/04447; H01M 8/04582; H01M 8/04753

(57) ABSTRACT

This application provides a method for controlling an anode purge valve of a fuel cell, a device, a medium, and a product, and relates to the field of fuel cell control technologies. The method includes: acquiring a system state of a fuel cell system and a corresponding reward value; inputting the system state of the fuel cell system and the corresponding reward value into a trained prediction model, to obtain a control action; the trained prediction model is a neural network model based on a reinforcement learning algorithm; and controlling an anode purge valve of the fuel cell system based on the control action. In this application, the reinforcement learning technology is introduced into the control of the anode purge valve of the fuel cell.

### CROSS REFERENCE TO RELATED APPLICATION

This patent application claims the benefit and priority of Chinese Patent Application No. 2024112150431, filed with the China National Intellectual Property Administration on Aug. 30, 2024, the disclosure of which is incorporated by reference herein in its entirety as part of the present application.

### TECHNICAL FIELD

The present disclosure relates to the field of fuel cell control technologies, and in particular to a method for controlling an anode purge valve of a fuel cell, a device, a medium, and a product.

### BACKGROUND

At present, a vehicle system of a fuel cell vehicle is driven by on an electrochemical reaction between hydrogen and oxygen. Such technology provides clean power support for vehicles, and avoids discharging harmful pollutants. Usually, a dead-end anode is used in proton exchange membrane fuel cell systems in vehicles. During operation, cathode nitrogen penetrates into an anode under driving of a concentration gradient. As a result, nitrogen accumulates on the anode, thereby reducing an anode hydrogen concentration.

For controlling of anode purge valves of high-power fuel cell systems, most systems perform cyclic exhausting according to working intervals and working times of fixed purge valves. In such method, working needs of the systems can be met under steady state conditions, but adjustment cannot be flexibly made under variable working conditions. In addition, because gas components cannot be observed in real time, in order not to lack fuel, the exhaust intervals are generally shorter. As a result, a large amount of hydrogen is discharged directly while not reacting, thereby reducing a hydrogen utilization rate and economic efficiency.

### SUMMARY

An objective of the present disclosure is to provide a method for controlling an anode purge valve of a fuel cell, a device, a medium, and a product, to flexibly control a purge value, thereby ensuring that a system operates stably and reliably.

To achieve the above objective, the present disclosure provides the following technical solutions.

According to a first aspect, the present disclosure provides a method for controlling an anode purge valve of a fuel cell. The method includes:
acquiring a system state of a fuel cell system and a corresponding reward value;
inputting the system state of the fuel cell system and the corresponding reward value into a trained prediction model, to obtain a control action, where the trained prediction model is a neural network model based on a reinforcement learning algorithm; and
controlling an anode purge valve of the fuel cell system based on the control action.

According to a second aspect, the present disclosure provides a computer device, including a memory, a processor, and a computer program stored in the memory and executable on the processor, where the computer program is executed by the processor to implement the method for controlling an anode purge valve of a fuel cell.

According to a third aspect, the present disclosure provides a computer-readable storage medium, storing a computer program thereon, where the computer program, when executed by a processor, implements the method for controlling an anode purge valve of a fuel cell.

According to a fourth aspect, the present disclosure provides a computer program product, including a computer program, where the computer program, when executed by a processor, implements the method for controlling an anode purge valve of a fuel cell.

According to specific embodiments provided in the present disclosure, the present disclosure provides the following technical effects:

The present disclosure provides a method for controlling an anode purge valve of a fuel cell, a device, a medium, and a product. First, the system state of the fuel cell system and the corresponding reward value are acquired. Then, the control action is obtained via the trained neural network model based on a reinforcement learning algorithm according to the system state of the fuel cell system and the corresponding reward value. Finally, the anode purge valve of the fuel cell system is controlled based on the control action. In the present disclosure, the reinforcement learning technology is introduced into the control of the anode purge valve of the fuel cell. Due to a strong self-adaptive capability and reinforcement learning's ability, and continuous interaction and optimization strategies with the fuel cell system, the trained prediction model can flexibly cope with complex and variable working conditions, so that stability and reliability of the system are effectively improved.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a flowchart of a method for controlling an anode purge valve of a fuel cell according to an embodiment of the present disclosure;

FIG. 2 is a schematic block diagram of a model of a fuel cell system model according to an embodiment of the present disclosure;

FIG. 3 is a flowchart of training of a reinforcement learning algorithm according to an embodiment of the present disclosure;

FIG. 4 is a schematic diagram of a method for controlling an anode purge valve of a fuel cell according to an embodiment of the present disclosure; and

FIG. 5 is a schematic diagram of a structure of a computer device according to an embodiment of the present disclosure.

### REFERENCE NUMERALS

1: hydrogen storage tank; 2: hydrogen pressure reducing valve; 3: intake pressure control proportional valve: 4: ejector; 5: inlet temperature sensor; 6: inlet pressure sensor; 7: outlet temperature sensor; 8: outlet pressure sensor; 9: water separator; 10: purge valve; 11: electric pile; 12: DCDC converter.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the utility model without creative efforts shall fall within the protection scope of the utility model.

With the continuous development of new energy technologies, as clean and efficient energy conversion devices, fuel cells have received extensive attention. In a fuel cell system, the control of an anode discharge valve is crucial for a hydrogen utilization rate and system stability. Usually, a dead-end anode is used in proton exchange membrane fuel cell systems in vehicles. During operation, nitrogen on a cathode side penetrates into an anode under driving of a concentration gradient. As a result, nitrogen accumulates on an anode side, thereby reducing an anode hydrogen concentration. If the purge valve cannot exhaust in time, the fuel cell may lack fuel, and catalyst dissolution and carbon corrosion may occur in serious cases, thereby affecting the operating life of the fuel cell system. Further, if continuous exhaust is performed to reduce the nitrogen concentration, a large amount of hydrogen is discharged directly while not reacting, thereby reducing a hydrogen utilization rate. This is not conducive to the economics of the fuel cell systems. Therefore, an important part of controlling the fuel cell systems is to determine an appropriate operating moment of the purge valve and determine the hydrogen utilization rate and accumulation of anode nitrogen.

At present, due to a strong self-adaptive capability and an efficient decision-making capability, reinforcement learning (RL) has achieved remarkable results in the fields of automatic driving, robot control, financial trading, game intelligences, medical diagnosis, and the like. Reinforcement learning is able to achieve efficient decision-making in complex and dynamic environments by learning through interaction with environments and continuously optimizing strategies. In the field of controlling the anode purge valve of the fuel cells, conventional control methods are difficult to cope with nonlinear and complex dynamic changes of systems, while reinforcement learning algorithms can effectively cope with the challenges and improve the stability and efficiency of the systems by continuously learning and adjusting strategies. Therefore, reinforcement learning has broad prospects in controlling the anode purge valve of the fuel cell, and is worthy of in-depth research and exploration.

To make the above objectives, features, and advantages of the present disclosure more obvious and easy to understand, the present disclosure will be further described in detail with reference to the accompanying drawings and specific implementations.

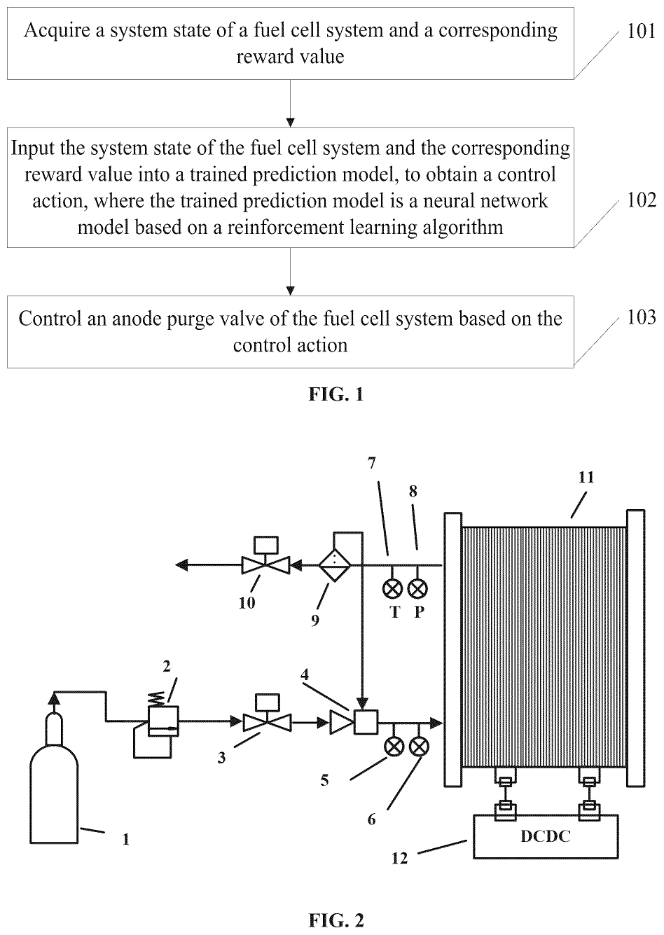

In an example embodiment, as shown in FIG. 1, a method for controlling an anode purge valve of a fuel cell is provided. The method includes step 101 to step 103.

Step 101: Acquire a system state of a fuel cell system and a corresponding reward value.

Step 102: Input the system state of the fuel cell system and the corresponding reward value into a trained prediction model, to obtain a control action, where the trained prediction model is a neural network model based on a reinforcement learning algorithm.

Step 103: Control an anode purge valve of the fuel cell system based on the control action.

Further, a reward function r for calculating the corresponding reward value is as follows:

$$r = \{ \begin{matrix}{k}_{1} {η}_{{H}_{2}} + {k}_{2} {r}_{1}^{+} & {S}_{purge} = 0 ⋂ {γ}_{{N}_{2}} < {γ}_{{N}_{2} , th} \\ {k}_{1} {η}_{{H}_{2}} + {k}_{2} {r}_{2}^{-} & {S}_{purge} = 0 ⋂ {γ}_{{N}_{2}} > {γ}_{{N}_{2} , th} \\ {k}_{1} {η}_{{H}_{2}} + {r}_{3}^{-} & {S}_{purge} = 1\end{matrix} ,$$

where
S_{purge} represents a state of the anode purge valve, 1 represents open, and 0 represents closed; γ_{N}_{₂} represents an anode nitrogen concentration, γ_{N}_{₂}_{,th} represents an anode nitrogen concentration threshold; η_{H}_{₂} represents a hydrogen utilization rate, r⁺ and r⁻ respectively represent a positive reward value and a negative reward value, and k₁ and k₂ both represent reward weight coefficients.

A reward value of each action pair is calculated based on the system state of the fuel cell system and a performance indicator. The reward value reflects impact of a current action on system performance, and is an important basis for optimizing strategies in a reinforcement learning process. The reward function specifies a learning goal of an intelligence by defining what is “good”. The intelligence achieves the learning goal by maximizing an accumulative reward (that is, retribution). In the present disclosure, it is necessary to enable the intelligence to possibly improve a hydrogen utilization rate of the system while maintaining an anode nitrogen concentration below a specific threshold.

Emphasis on the reward function may be changed by adjusting magnitudes of the two coefficients k₁ and k₂ in the reward function to formulate a more conservative (tending to maintain a low nitrogen concentration) or a more aggressive (tending to maintain a high hydrogen utilization rate) exhaust strategy.

According to the reward function, the hydrogen utilization rate is a continuous reward, and needs to be given all the time. Three states corresponding to the formula are as follows: 1. When the purge valve is closed and the nitrogen concentration is lower than a threshold, an additional reward needs to be given. 2. When the purge valve is closed and the nitrogen concentration is higher than a threshold, an additional penalty needs to be given. 3. When the purge valve is open, an additional penalty needs to be given.

Further, the system state includes a cathode gas temperature, an anode gas temperature, a cathode gas pressure, an anode gas pressure, an anode nitrogen concentration, a hydrogen utilization rate, and a load current. The control action includes opening the anode purge valve of the fuel cell system and closing the anode purge valve of the fuel cell system.

Further, the reinforcement learning algorithm is a twin delayed deep deterministic policy gradient algorithm (TD3).

The TD3 is an advanced reinforcement learning algorithm, and used to train an intelligence, to resolve problems in continuous action space. Compared with a conventional deep deterministic policy gradient (DDPG), stability and performance are improved according to the TD3. The TD3 adopts a dual-goal Q network and a delayed update strategy, and reduces over-estimation by minimizing a difference between two Q values, thereby improving stability of training and convergence speed. In addition, TD3 introduces a goal strategy network (an actor network) and a dual-goal Q network (a critic network), to reduce over-optimization by delaying the update of the goal network. This further improves the performance and a generalization capability of the intelligence in complex environments. The TD3 has been widely applied to various continuous control problems, for example, robotics learning and autonomous driving, and shows superior performance in dealing with actual complex tasks.

Further, a process of determining the trained prediction model includes:
constructing a fuel cell system model;
initializing the fuel cell system model; and
performing reinforcement learning training on a prediction model based on the fuel cell system model that is initialized, to obtain the trained prediction model.

As an optional implementation, as shown in FIG. 2, the fuel cell system model includes a hydrogen storage tank 1, a hydrogen pressure reducing valve 2, an inlet pressure control proportional valve 3, an ejector 4, an inlet temperature sensor 5, an inlet pressure sensor 6, an outlet temperature sensor 7, an outlet pressure sensor 8, a water separator 9, an purge valve 10, an electric pile 11, and a DCDC converter 12.

There are two control component actuators of a hydrogen supply system, namely, an inlet pressure control proportional valve 3 and an outlet purge valve 10. Feedback control of an inlet pressure is completed by adjusting opening of the inlet pressure control proportional valve 3, and an exhaust operation is performed by adjusting the opening and closing of the purge valve 10.

### Roles of Main Components:

An electric pile 11 (that is, a fuel cell): used to generate electricity. Generally, the fuel cell generates heat while generating electricity.

Inlet pressure sensor 6 and outlet pressure sensor 8: used to obtain gas pressure information for entering and exiting a pile.

Inlet pressure control proportional valve 3: used to control a pressure of inlet hydrogen by adjusting opening of the inlet pressure control proportional valve 3. It is also referred to as a hydrogen inlet proportional valve or a proportional valve in this specification.

Water separator 9: used to separate a liquid water component in an anode outlet gas.

Purge valve 10: for discharging an anode gas. The present disclosure is primarily concerned with the actuator.

Ejector 4: for ensuring a flow of hydrogen and recirculation of hydrogen.

An approximate work flow of the fuel cell system is as follows: First, hydrogen enters the anode of the fuel cell from the high-pressure hydrogen storage tank 1 via the hydrogen pressure reducing valve 2 and the proportional valve 3. Hydrogen participating in the reaction, a small amount of nitrogen, and water vapor are discharged via the purge valve 10. The water separator 9 is used to separate the liquid water generated by the reaction. The ejector 4 is used to recirculate the hydrogen.

Further, the performing reinforcement learning training on a prediction model based on the fuel cell system model that is initialized, to obtain the trained prediction model specifically includes:
initializing a network parameter of the prediction model;
randomly sampling a specific quantity of state-action pairs in an experience pool, where the state-action pairs in the experience pool are derived from an interaction process between the prediction model and the fuel cell system model; the state-action pairs each include a first system state, a control action, a reward value, and a second system state; the reward value is obtained through calculation based on the first system state; and the second system state is a response state of the fuel cell system model after the control action is executed in the first system state; and
updating the network parameter of the prediction model based on the state-action pair, returning to randomly sampling a specific quantity of state-action pairs in an experience pool, and iteratively repeating until accumulative reward values converge, to obtain the trained prediction model.

In the present disclosure, the first system state is also referred to as a current state, and the control action is also referred to as an action.

Experience playback is a step in the TD3. Experience playback: During system operation, system state information (a system temperature, a load current, a cathode gas pressure, an anode gas pressure, an estimated value of an anode nitrogen concentration, and an estimated value of a hydrogen utilization rate) and a corresponding action pair (that is, an action command of the purge valve) are recorded. The station-action pair data are stored in an experience playback module (that is, the experience pool), to form an experience playback memory. The experience playback module is to use the historical data in subsequent reinforcement learning training, to enable the learning process to be more stable and efficient.

The system temperature may be obtained via the inlet temperature sensor 5 and the outlet temperature sensor 7. The cathode gas pressure and the anode gas pressure may be obtained via the inlet pressure sensor 6 and the outlet pressure sensor 8.

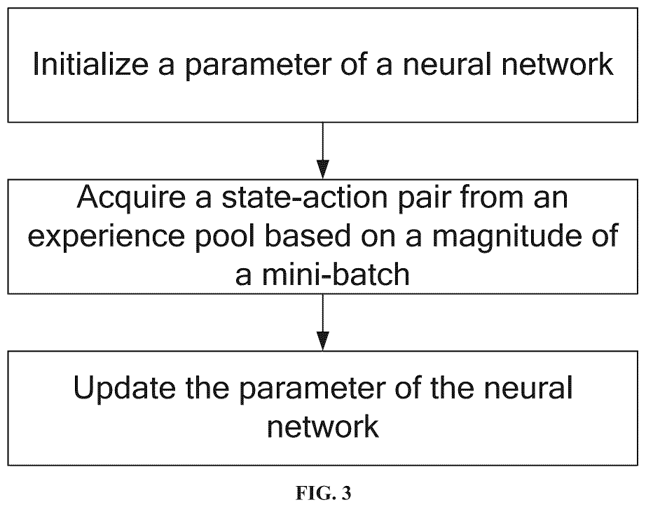

As an optional implementation, referring to FIG. 3, the specific training process based on the TD3 is as follows:

Initialize two critic network parameters w₁, w₂ and one actor network parameter θ.

Initialize two target critic network parameters and one target actor network parameter as follows:

$${w}_{1} \to {\overline{w}}_{1} , {w}_{2} \to {\overline{w}}_{2} , θ \to \overline{θ} ,$$

where
w̅₁, w̅₂, θ represent initial values of corresponding network parameters respectively.

Initialize the number of buffers (caches) of experience pools.

Action exploration noise, a˜π(s)₊Ò, Ò∈N(0, σ), a reward value r, and a next state s′ are set, and stored in the experience pool (s, a, r, s′) as a state-action pair, where π(S) represents an output strategy while the state is s, Ò represents noise, and N(0, σ) represents Gaussian distribution (normal distribution) with a mathematical expectation of 0 and a standard variance of σ, that is, the noise conforms to Gaussian distribution, and is also known as Gaussian noise.

For the state-action pair, an action a is a state of the purge valve. A current state s includes a load current, a system temperature, a cathode gas pressure, an estimated value of an anode nitrogen concentration, and an estimated value of a hydrogen utilization rate. r represents a reward value (the form of the reward function has been given previously) calculated based on the current state s. When the current state is s and the reward value is r, the action a is performed, and a response state of the system at a next moment is s′.

State-action pairs are randomly sampled in the experience pool based on a magnitude of a preset mini-batch (small batch). (s, a, r, s′) The sampled state-action pairs participate in updating the parameter of the TD3 neural network.

The target actor network outputs actions to the critic network for network update:

$${π}_{\overline{θ}} ( s ) + {ò}^{′} \to \tilde{a} , {ò}^{′} ∼ clip ( N ( 0 , σ ) , - c , c ) ,$$

where π_{θ̅}( ) represents a target behavior strategy when the network parameter is θ̅, Ò′ represents Gaussian noise of the target behavior strategy, and a clip (, ,) function is used to limit a value of the Gaussian noise between a given minimum value −c and a given maximum value c. That is, if the value of the Gaussian noise is greater than the maximum value c, the value of the Gaussian noise is equal to the maximum value c. If the value of the Gaussian noise is smaller than the minimum value −c, the value of the Gaussian noise is equal to the minimum value −c.

$${Q}_{\overline{w}}^{target}$$

is calculated using the estimated action ã, the reward value estimated by the critic network, and the smaller value calculated using the two critic networks:

$${Q}_{\overline{w}}^{target} = r + γ \cdot {min}_{i = 1 , 2} {Q}_{{\overline{w}}_{i}} ( {s}^{′} , \tilde{a} ) ,$$

where
r represents a reward value estimated by the critic network based on the estimated action ã, γ represents an attenuation coefficient, and Q_{w̅}_{ᵢ}(s′, ã) represents the Q values whose, network parameter is w̅ᵢ and that is calculated by the critic network based on a state s′ and an action ã.

Calculate a critic loss function J(wᵢ), and update the critic network parameter w₁, w₂ using a gradient descent method,

$$J ( {w}_{i} ) = \frac{1}{N} \sum {( {Q}_{\overline{w}}^{target} - {Q}_{{w}_{i}} ( s , a ) )}^{2} ,$$

where

N represents the number of samples in the mini-batch (the small batch),

$${Q}_{\overline{w}}^{target}$$

represents a target Q value and is an estimated value of future retribution calculated using the current strategy or the target strategy, and Q_{w}_{ᵢ}(s,a) represents an estimated value of the current Q value function when the network parameter is wᵢ.

Update the actor network parameter θ based on a deterministic gradient strategy:

$${∇}_{θ} J ( θ ) = \frac{1}{N} \sum {∇}_{a} {Q}_{{w}_{1}} ( s , a ) {\vert}_{a = {π}_{θ} ( s )} {∇}_{θ} ( s ) ,$$

where
∇_{θ}J(θ) Represents a gradient of a loss function relative to a strategy parameter θ, ∇ₐQ_{w}_{₁}(s, a)|_{a=π}_{_{θ}}₍ₛ₎ represents a gradient of an action value function relative to the action, a=π_{θ}(s) represents that the action a is generated based on the current strategy π_{θ}, and ∇_{θ}π_{θ}(s) represents a gradient of the strategy function relative to the strategy parameter θ.

Update the target network parameter:

$${\overline{w}}_{i} = {ρ}_{w} {w}_{i} + ( 1 - {ρ}_{w} ) {\overline{w}}_{i} ,$$

$$\overline{θ} = {ρ}_{θ} θ + ( 1 - {ρ}_{θ} ) \overline{θ} ,$$

where

ρ_{w} and ρ_{θ} respectively represent learning rates of the critic network and the actor a and network.

The training process circulates continuously. Simulation training is performed under various current working conditions based on a preset random current. When accumulative reward values of each episode (round, also known as turn) of the simulation result converge, it may be determined that the reinforcement learning algorithm has completed its own training, and may be used for actual purposes.

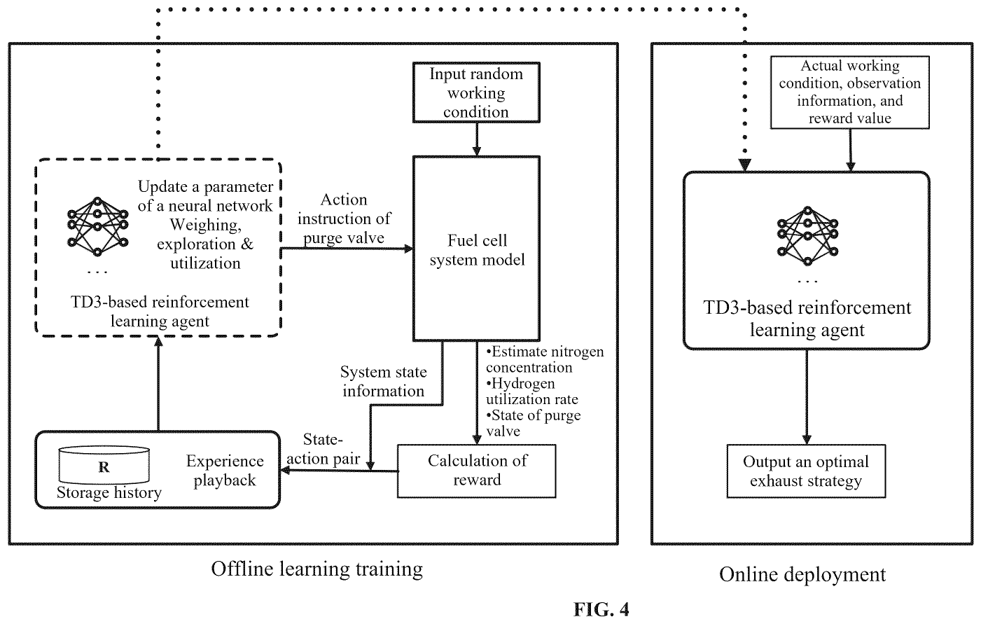

The final result is a reinforcement learning agent (agent), specifically, parameters such as the TD3 of a neural network model included in the agent. The parameters are equivalent to a complete TD3-based reinforcement learning agent. As shown in FIG. 4, the “TD3-based reinforcement learning agent” on the lower side is the process of training, the “TD3-based reinforcement learning agent” on the upper side is the trained model on the left side, and the trained model may be used for actual purposes.

The purge valve of an actual fuel cell system is controlled based on the trained reinforcement learning algorithm.

Under operating conditions of the actual system, a corresponding state quantity s and a reward value feedback r are given for the reinforcement learning algorithm. An appropriate value of the action state a of the purge valve is output based on the algorithm, to achieve the best control effect of implementing the accumulative reward function.

Further, the initializing the fuel cell system model specifically includes:
taking a variation range of a load current of the fuel cell system model as a preset range, where the preset range is a variation range of a load current of an actual fuel cell system under a corresponding operating condition; and
setting a variation type of the load current of the fuel cell system model to a random variation.

As an optional implementation, the initialization process is to randomly load a current condition in the fuel cell system model.

The initialization herein means the design of simulation working conditions. The initialization of the fuel cell system model is mainly to conduct the design of the random current condition, because the training for the neural network is generally circulated. For simulation, a magnitude of the load current is randomly varied each time within a specific range, to enable the trained reinforcement learning algorithm to have applicable performance under various working conditions.

In an example embodiment, the method for controlling an anode purge valve of a fuel cell may further include:

Step 201: Initialize the fuel cell system model, where the initialization process is to randomly load the current condition. Data required for subsequent steps is obtained via the fuel cell system model.

Step 202: Determine the number of observation quantities and output quantities of the reinforcement learning algorithm, and respective value ranges. The observation quantity is the system state s, and the output quantity is the control action a.

Step 203: Determine the form of the reward function.

The reward value of each action pair is calculated based on the system state of the fuel cell system and a performance indicator. The reward value reflects impact of a current action on system performance, and is an important basis for optimizing strategies in a reinforcement learning process. The reward function specifies a learning goal of an intelligence by defining what is “good”. The intelligence achieves the learning goal by maximizing an accumulative reward (that is, retribution). The specific form of the reward function is shown in the above.

Step 204: Perform reinforcement learning training, based on the random working condition in step 201, on the state-action pairs determined in step 202 and the reward function determined in step 3.

Step 204 is a stage of reinforcement learning training. After all conditions are prepared, training is performed based on the TD3-based reinforcement learning algorithm, to update the parameters of the neural network.

Generally, the present disclosure implements the intelligent control of the purge valve by means of two stages, namely, offline learning training and online deployment.

### 1. Offline Learning Training

1.1 Initialization and data acquisition: First, the fuel cell system model is initialized. To ensure that sufficient training data for the model may be obtained under different working conditions, the random current conditions are entered. This model includes key parameters of the fuel cell system, such as the estimated nitrogen concentration, the hydrogen utilization rate, and the state of the purge valve. The data are used in the subsequent training process.

### 1.2 Calculation of Rewards

### 1.3 Reinforcement Learning Training

After sufficient training, the reinforcement learning agent outputs optimized exhaust strategies. The strategies are used in control of an actual system during online deployment.

### 2. Online Deployment

2.1 System operation and monitoring: The fuel cell system operates in real time under the actual working conditions. Real-time statuses and performance indicators of the system are obtained via a sensor and a monitoring device. The actual working condition, the observation information, and the reward value are transmitted to the prediction model in real time for online optimization.

2.2 Online optimization of reinforcement learning: A TD3-based prediction model receives observation data in real time from the fuel cell system during online deployment. The prediction model performs online adjustment and optimization based on the policies obtained from the offline training and current real-time data. Such online optimization mechanism ensures that the system may efficiently operate under dynamic operating conditions.

2.3 Execution of exhaust strategy: The prediction model outputs the optimal exhaust strategy instructions based on real-time data and optimization strategies. The system accurately controls the discharge of hydrogen according to the instructions.

In terms of optimizing the control effect of the anode purge valve of the fuel cell, according to the present disclosure, the system has the following advantages:

(1) Various complex working conditions can be met via the prediction model on which enhancement learning training is performed, and the optimal control strategy of the purge valve is formulated.

(2) Emphasis on the hydrogen utilization rate and the nitrogen concentration are changed by modifying weights of values in the reward function, thereby obtaining a conservative control strategy or a radical control strategy by training.

(3) In the method for controlling an anode purge valve of a fuel cell provided in the present disclosure, which is based on enhancement learning, the hydrogen utilization rate and overall performance of the fuel cell system is significantly improved by offline learning and online optimization. During offline learning, the system performs optimizes strategy optimization based on historical data and the TD3 algorithm. During online deployment, the learning agent adjusts the strategy in real time, to ensure efficient operation of the system under dynamic conditions. The method not only improves stability and reliability of the system, but also provides a new solution for intelligent control of the fuel cell. According to the control method in the present disclosure, the system not only can cope with the complex working conditions, but also can adjust the emphasis on the control strategy as required, thereby better meeting requirements of different application scenarios.

The present disclosure further provides an application scenario to which the method for controlling an anode purge valve of a fuel cell is applied. Specifically, the method for controlling an anode purge valve of a fuel cell provided in the embodiments may be applied to a performance control scenario of a fuel cell system of a new energy vehicle.

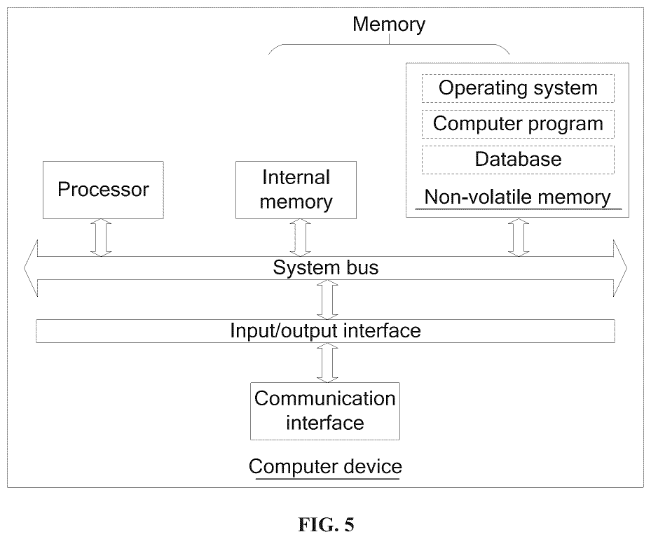

In an example embodiment, a computer device is provided. The computer device may be a server, and an internal structure thereof may be as shown in FIG. 5. The computer device includes a processor, a memory, an input/output (I/O) interface and a communication interface. The processor, the memory and the input/output interface are connected through a system bus. The communication interface is connected to the system bus through the input/output interface. The processor of the computer device is configured to provide computing and control capabilities. The memory of the computer device includes a nonvolatile storage medium and an internal memory. The non-volatile storage medium stores an operating system, a computer program, and a database. The internal memory provides an environment for operation of the operating system and the computer program in the nonvolatile storage medium. The database of the computer device is configured to store data related to the fuel cell system. The input/output interface of the computer device is configured to exchange information between the processor and an external apparatus. The communication interface of the computer device is configured to communicate with an external terminal through a network. The computer program, when executed by the processor, implements the method for controlling an anode purge valve of a fuel cell.

Those skilled in the art may understand that the structure shown in FIG. 5 is only a block diagram of a part of the structure related to the solution of the present disclosure and does not constitute a limitation on a computer device to which the solution of the present disclosure is applied. Specifically, the computer device may include more or fewer components than those shown in the figure, or combine some components, or have different component arrangements.

In an example embodiment, a computer device is provided, including a memory and a processor. The memory stores a computer program, and the computer program is executed by the processor to implement the steps of the above method embodiment.

In an example embodiment, a computer-readable storage medium is provided. The computer-readable storage medium stores a computer program, and the computer program is executed by a processor to implement the steps of the above method embodiment.

In an example embodiment, a computer program product is provided, including a computer program. The computer program is executed by the processor to implement the steps of the above method embodiment.

Those of ordinary skill in the art may understand that all or some of the procedures in the method in the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a storage, a database, or other media used in the embodiments of the present disclosure may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), and a graphene memory. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor, a programmable logic device, and a data processing logic device based on quantum computing, but is not limited thereto.

The technical characteristics of the above embodiments can be employed in arbitrary combinations. To provide a concise description, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of the present disclosure. The description of the foregoing embodiments is used to help illustrate the method in present disclosure and the core principles thereof. In addition, those of ordinary skill in the art can make various modifications in terms of specific implementations and scope of application in accordance with the teachings of the present disclosure. In conclusion, the content of the present specification shall not be construed as a limitation to the present disclosure.

1. A method for controlling an anode purge valve of a fuel cell, comprising:
acquiring a system state of a fuel cell system and a corresponding reward value;
wherein the system state comprises a cathode gas temperature, an anode gas temperature, a cathode gas pressure, an anode gas pressure, an anode nitrogen concentration, a hydrogen utilization rate, and a load current; a reward function r for calculating the corresponding reward value is as follows:
$$r = \{ \begin{matrix}{k}_{1} {η}_{{H}_{2}} + {k}_{2} {r}_{1}^{+} & {S}_{purge} = 0 ⋂ {γ}_{{N}_{2}} < {γ}_{{N}_{2} , th} \\ {k}_{1} {η}_{{H}_{2}} + {k}_{2} {r}_{2}^{-} & {S}_{purge} = 0 ⋂ {γ}_{{N}_{2}} > {γ}_{{N}_{2} , th} \\ {k}_{1} {η}_{{H}_{2}} + {r}_{3}^{-} & {S}_{purge} = 1\end{matrix} ,$$
wherein S_{purge} represents a state of the anode purge valve, 1 represents open, and 0 represents closed: γ_{N}_{₂} represents an anode nitrogen concentration, γ_{N}_{₂}_{,th} represents an anode nitrogen concentration threshold: η_{H}_{₂} represents a hydrogen utilization rate, r⁺ and r⁻ respectively represent a positive reward value and a negative reward value, and k₁ and k₂ both represent reward weigh coefficients;
inputting the system state of the fuel cell system and the corresponding reward value into a trained prediction model, to obtain a control action, wherein the trained prediction model is a neural network model based on a reinforcement learning algorithm, the reinforcement learning algorithm is a twin delayed deep deterministic policy gradient algorithm, and the control action comprises opening the anode purge valve of the fuel cell system and closing the anode purge valve of the fuel cell system; and
controlling an anode purge valve of the fuel cell system based on the control action.

2. (canceled)

3. (canceled)

4. (canceled)

5. The method for controlling an anode purge valve of a fuel cell according to claim 1, wherein a process of determining the trained prediction model comprises:
constructing a fuel cell system model;
initializing the fuel cell system model; and
performing reinforcement learning training on a prediction model based on the fuel cell system model that is initialized, to obtain the trained prediction model.

6. The method for controlling an anode purge valve of a fuel cell according to claim 5, wherein performing the reinforcement learning training on a prediction model based on the fuel cell system model that is initialized, to obtain the trained prediction model specifically comprises:
initializing a network parameter of the prediction model;
randomly sampling a specific quantity of state-action pairs in an experience pool, wherein the state-action pairs in the experience pool are derived from an interaction process between the prediction model and the fuel cell system model; the state-action pairs each comprise a first system state, a control action, a reward value, and a second system state; the reward value is obtained through calculation based on the first system state; and the second system state is a response state of the fuel cell system model after the control action is executed in the first system state; and
updating the network parameter of the prediction model based on the state-action pairs, returning to randomly sampling a specific quantity of state-action pairs in an experience pool, and iteratively repeating until accumulative reward values converge, to obtain the trained prediction model.

7. The method for controlling an anode purge valve of a fuel cell according to claim 5, wherein initializing the fuel cell system model specifically comprises:
taking a variation range of a load current of the fuel cell system model as a preset range, wherein the preset range is a variation range of a load current of an actual fuel cell system under a corresponding operating condition; and
setting a variation type of the load current of the fuel cell system model to a random variation.

8. A computer device, comprising a memory, a processor, and a computer program stored in the memory and executable on the processor, wherein the computer program is executed by the processor to implement the method for controlling an anode purge valve of a fuel cell in claim 1.

9. A computer-readable storage medium, storing a computer program thereon, wherein the computer program, when executed by a processor, implements the method for controlling an anode purge valve of a fuel cell in claim 1.

10. (canceled)

11. (canceled)

12. (canceled)

13. (canceled)

14. The computer device according to claim 8, wherein a process of determining the trained prediction model comprises:
constructing a fuel cell system model;
initializing the fuel cell system model; and
performing reinforcement learning training on a prediction model based on the fuel cell system model that is initialized, to obtain the trained prediction model.

15. The computer device according to claim 14, wherein performing the reinforcement learning training on a prediction model based on the fuel cell system model that is initialized, to obtain the trained prediction model specifically comprises:
initializing a network parameter of the prediction model;
randomly sampling a specific quantity of state-action pairs in an experience pool, wherein the state-action pairs in the experience pool are derived from an interaction process between the prediction model and the fuel cell system model;
the state-action pairs each comprise a first system state, a control action, a reward value, and a second system state; the reward value is obtained through calculation based on the first system state; and the second system state is a response state of the fuel cell system model after the control action is executed in the first system state; and
updating the network parameter of the prediction model based on the state-action pairs, returning to randomly sampling a specific quantity of state-action pairs in an experience pool, and iteratively repeating until accumulative reward values converge, to obtain the trained prediction model.

16. The computer device according to claim 14, wherein initializing the fuel cell system model specifically comprises:
taking a variation range of a load current of the fuel cell system model as a preset range, wherein the preset range is a variation range of a load current of an actual fuel cell system under a corresponding operating condition; and
setting a variation type of the load current of the fuel cell system model to a random variation.

17. (canceled)

18. (canceled)

19. (canceled)

20. The computer-readable storage medium according to claim 9, wherein a process of determining the trained prediction model comprises:
constructing a fuel cell system model;
initializing the fuel cell system model; and
performing reinforcement learning training on a prediction model based on the fuel cell system model that is initialized, to obtain the trained prediction model.

21. The computer-readable storage medium according to claim 20, wherein performing the reinforcement learning training on a prediction model based on the fuel cell system model that is initialized, to obtain the trained prediction model specifically comprises:
initializing a network parameter of the prediction model;
randomly sampling a specific quantity of state-action pairs in an experience pool, wherein the state-action pairs in the experience pool are derived from an interaction process between the prediction model and the fuel cell system model; the state-action pairs each comprise a first system state, a control action, a reward value, and a second system state; the reward value is obtained through calculation based on the first system state; and the second system state is a response state of the fuel cell system model after the control action is executed in the first system state; and
updating the network parameter of the prediction model based on the state-action pairs, returning to randomly sampling a specific quantity of state-action pairs in an experience pool, and iteratively repeating until accumulative reward values converge, to obtain the trained prediction model.

22. The computer-readable storage medium according to claim 20, wherein initializing the fuel cell system model specifically comprises:
taking a variation range of a load current of the fuel cell system model as a preset range, wherein the preset range is a variation range of a load current of an actual fuel cell system under a corresponding operating condition; and
setting a variation type of the load current of the fuel cell system model to a random variation.
